(19) United States
(12) Patent Application Publication
(10) Pub. No.: US 2002/0116315 A1
(43) Pub. Date: Aug. 22, 2002

(54) System and method for bidding in multiple auctions

(76) Inventors: William Grey, Millwood, NY (US); Clifford A. Pickover, Yorktown Heights, NY (US); Paul A. Moskowitz, Yorktown Heights, NY (US); Stephen J. Boies, Mahopac, NY (US)

Correspondence Address: BUCKLEY, MASCHOFF, TALWALKAR, & ALLISON, 5 ELM STREET, NEW CANAAN, CT, 06840, US

(21) Appl. No.: 09/784,916

(22) Filed: Feb. 16, 2001

(51) Int. Cl. G06F 17/60

(52) U.S. Cl. 705/37

(57) ABSTRACT

A system, method, apparatus and medium to obtain an item includes identification of a plurality of auctions in which the item is being auctioned, and automatically submission of one or more bids to a plurality of the plurality of auctions in order to obtain the item. As a result of these features, the present invention may automatically execute a bidding strategy to obtain for a desired price an item being auctioned in more than one auction.

### BACKGROUND OF THE INVENTION

1. Field of the Invention

The present invention relates to auctions. More specifically, the invention relates to systems for submitting auction bids in order to obtain one or more desired items.

2. Description of the Related Art

Auctions are often used to sell goods and/or services to buyers. In the present disclosure, goods and/or services sold in this manner are referred to as items. According to a typical auction, an item is presented to prospective buyers and a first bid is submitted by one of the buyers. The first bid includes a first bid price and an agreement to purchase the item for the first bid price. The buyers are notified of the first bid, and if one of the buyers is willing to purchase the item for a second price that is greater than the first bid price, a second bid including the second price may be submitted. It should be noted that a submitted bid including a bid price that is greater than the bid price of any other submitted bid will be referred to as a current bid and the associated bid price will be referred to as a current bid price. Accordingly, the second bid and the second bid price become the current bid and the current bid price, respectively.

Subsequent bids representing increasing bid prices may be accepted until the auction is deemed complete based on some criterion, such as a time limit. At the completion of the auction, the current bid prevails. That is, once the auction is deemed complete, the item is sold for the bid price included in the current bid to the buyer who submitted the current bid.

Of course, an auction may be conducted using any of several known auction methods different from that described above. Moreover, an auction may be conducted by a seller of an item or by another entity to which the seller provides the right to auction the item. Examples of such an entity include an auction house (e.g. Sotheby's™) or an online auction service (e.g. eBay™).

Recent growth in online auction services has greatly increased the number of auctions accessible to a typical buyer. Buyers are attracted to these auctions by the prospect of obtaining a hard-to-find item or of obtaining a desired item for a bargain price. However, in a case that an item is presented in multiple auctions, it is difficult and time-consuming for a buyer to devise and to implement a bidding strategy that is reasonably likely to result in the buyer obtaining a desired quantity of the item at an acceptable price.

In view of the foregoing, what is needed is a system to facilitate bidding for an item being auctioned in more than one auction.

### SUMMARY OF THE INVENTION

In order to address the foregoing needs, the present invention provides a system, method, apparatus and medium to identify a plurality of auctions in which an item is being auctioned, and to automatically submit one or more bids to a plurality of the plurality of auctions in order to obtain the item. As a result of these features, the present invention may automatically execute a bidding strategy to obtain for a desired price an item being auctioned in more than one auction.

In a further aspect of the present invention, one or more bids are automatically submitted by identifying one of the plurality of the plurality of auctions having a lowest next bid price for the item, wherein a next bid price in a particular auction for a particular item is based on a sum of a current bid price for the particular item in the particular auction and a minimum bidding increment associated with the particular auction. By identifying the lowest next bid price based on the minimum bidding increment, this further aspect provides accurate identification of an auction having a lowest next bid price for an item. As a result, the item may be obtained for a lowest possible price.

Even further to the above aspects, one or more bids may be automatically submitted by determining whether the lowest next bid price is greater than a maximum bid price, and, if it is determined that the lowest next bid price is not greater than the maximum bid price, by submitting to the one auction a bid for the item, the bid being based on the lowest next bid price. Advantageously, this aspect may ensure that an item is not obtained for a price greater than the buyer is willing to pay.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to obtain an item according to embodiments of the present invention.

FIG. 2 is a topographic view of a network architecture according to embodiments of the present invention.

FIG. 3 is a block diagram of an internal architecture of an auction device according to embodiments to the present invention.

FIG. 4 is a block diagram of an internal architecture of a user device according to embodiments to the present invention.

FIG. 5 is a representative view of a tabular portion of an auction database according to embodiments of the present invention.

FIG. 6 is a representative view of a tabular portion of an auction information database according to embodiments of the present invention.

FIGS. 7A and 7B are a flow diagram of process steps to obtain an item according to embodiments of the present invention.

### DETAILED DESCRIPTION

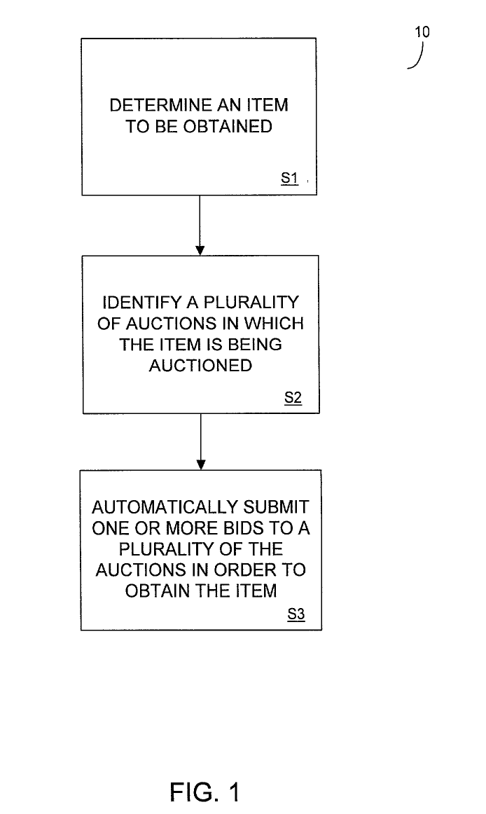

FIG. 1 is a flow diagram of process steps 10 according to embodiments of the invention. Process steps 10 will be described initially below without reference to a specific example in the interest of providing an immediate introduction to features of the present invention. Accordingly, process steps 10 will be described later with respect to a specific example and specific hardware and software embodiments, along with details of alternative embodiments.

Process steps 10 begin at step S1, in which an item to be obtained is determined. The determination in step S1 may be based on user input indicating a desired item. Next, in step S2, a plurality of auctions in which the item is being auctioned are identified. Finally, in step S3, one or more bids are automatically submitted to two or more of the plurality of the auctions in order to obtain the item. As described above, the process steps 10 provide automatic execution of a bidding strategy to obtain for a desired price an item being auctioned in more than one auction.

Network Architecture

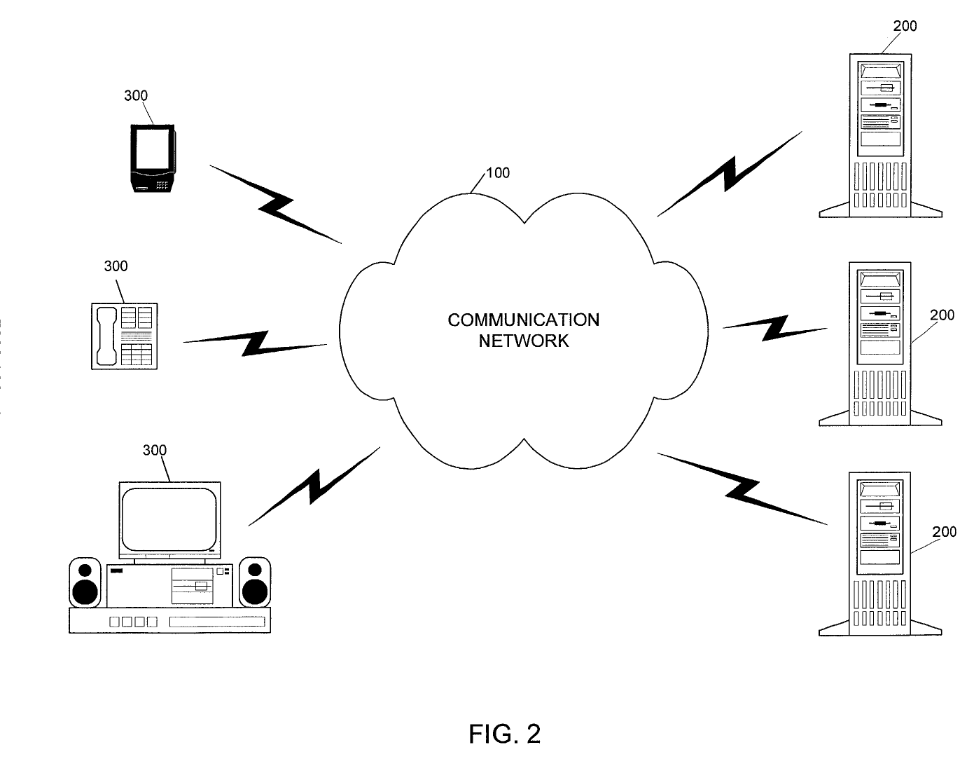

FIG. 2 is a topographic view of a network architecture according to embodiments of the present invention. Of course, many other architectures may be used to implement the invention. Shown in FIG. 2 is communication network 100 in communication with various auction devices 200 and user devices 300. It should be noted that the devices shown in communication with communication network 100 need not be constantly exchanging data. Rather, communication may be established when necessary and severed at other times or always available but rarely used to transmit data. Moreover, although the illustrated communication links between the components of FIG. 2 appear dedicated, it should be noted that each of the connections may be shared by other components.

Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP).

Auction devices 200 as depicted in FIG. 2 and described herein are dedicated World Wide Web servers. As will be understood, other devices may be used as auction devices 200 in accordance with the present invention, including mainframe computers, workstations, kiosks, networks and any combination thereof. Auction devices 200 may be used to present items being auctioned to a user spontaneously or in response to a request from the user, to present auction rules and other administrative information to the user, to accept submitted bids from the user, to determine the user to whom the item should be sold at the conclusion of an auction, and to settle the purchase of the item between the determined buyer, the auctioning entity, and the seller, if different from the auctioning entity.

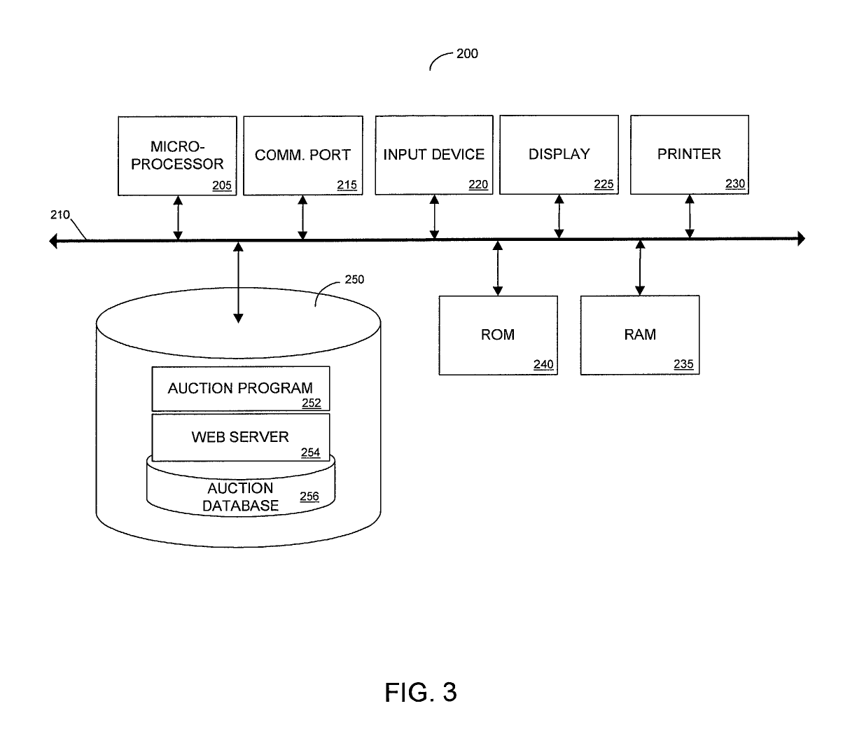

Generally, one or more of auction devices 200 may be operated by an entity such as an auction house, an online auction service, and a private seller to conduct one or more simultaneous auctions. Accordingly, one auction device 200 may be operated by a single auctioning entity to conduct one or more simultaneous auctions. Further details of one auction device 200 according to embodiments of the invention are set forth below with respect to FIG. 3.

In communication with auction devices 200 through communication network 100 are several user devices 300 comprising a telephone, a personal digital assistant and a workstation. User devices 300 are used to communicate with auction devices 200 in order to obtain auctioned items. In this regard, user devices 300 usable in conjunction with the present invention include any device capable of presenting information to a user, visually and/or aurally, and of transmitting an indication made by the user to an external device. Of course, user devices 300 should be able to communicate with the device or devices with which they are in communication over whatever type of network media exist between the devices.

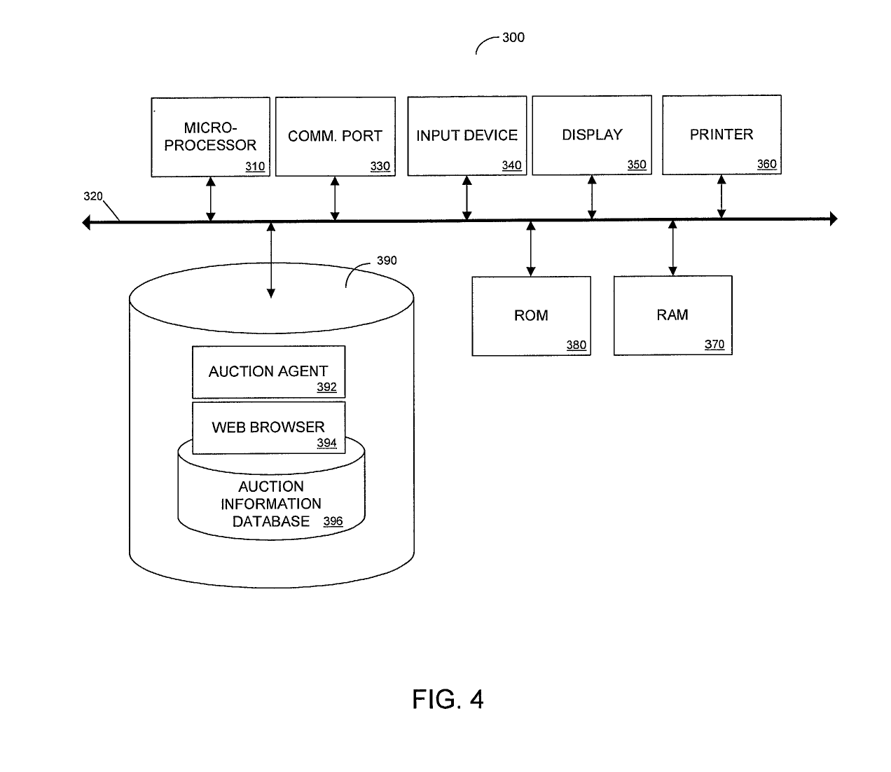

User devices 300 may be used to execute process steps 10 in accordance with the present invention. Generally, each of user devices 300 may be operated by a user to access one or more auctions executing in one or more of auction devices 200, to identify two or more auctions in which a desired item is being auctioned, and to automatically submit one or more bids to two or more of the identified auctions in order to obtain the item. Details of one embodiment of a user device 300 are set forth below with respect to FIG. 4.

Auction Device

FIG. 3 is a block diagram of the internal architecture of an auction device 200 according to one embodiment of the invention. As illustrated, auction device 200 includes microprocessor 205 in communication with communication bus 210. Microprocessor 205 may be a Pentium™, RISC™-based, or other type of processor and is used to execute processor-executable process steps so as to control the components of auction device 200 to provide desired functionality.

Also in communication with communication bus 210 is communication port 215. Communication port 215 is used to transmit data to and to receive data from external devices. Communication port 215 is therefore preferably configured with hardware suitable to physically interface with desired external devices and/or network connections. In one embodiment, bidding and other auction information is transmitted to and bids are received from user devices 300 over communication port 215.

Input device 220, display 225 and printer 230 are also in communication with communication bus 210. Any known input device may be used as input device 220, including a keyboard, mouse, touch pad, voice-recognition system, or any combination of these devices. Input device 220 may be used by an auctioning entity operating auction device 200 to input information regarding items to be auctioned, such as a description and a starting bid price. Of course, such information may also be input to auction device 200 via communication port 215. Input device 220 may also be used to input commands for controlling operation of auction device 200, such as commands to begin an auction, to stop an auction, and to output a report detailing auction statistics.

Such a report may be output to display 225, which may be an integral or separate CRT display, flat-panel display or the like. Display 225 is generally used to output graphics and text to an operator in response to commands issued by microprocessor 205. Printer 230 may also output graphics and text, but in hardcopy form using ink-jet, thermal, dot-matrix, laser, or other printing technologies.

RAM 235 is connected to communication bus 210 to provide microprocessor 205 with fast data storage and retrieval. In this regard, processor-executable process steps being executed by microprocessor 205 are typically stored temporarily in RAM 235 and executed therefrom by microprocessor 205. ROM 240, in contrast, provides storage from which data can be retrieved but to which data cannot be stored. Accordingly, ROM 240 is used to store invariant process steps and other data, such as basic input/output instructions and data used during system boot-up or to control communication port 215.

Data storage device 250 stores, among other data, auction program 252 of processor-executable process steps. Microprocessor 205 executes instructions of auction program 252 in order to control auction device 200 to conduct one or more auctions as described above. In addition, auction program 252 may include process steps of an interactive voice response system enabling auction device 200 to transmit inquiries to and receive responses from a user using a telephone user device 300. Also stored in data storage device 250 are processor-executable process steps of Web server 254. Web server 254 allows auction device 200 to communicate with user devices 300 over the World Wide Web.

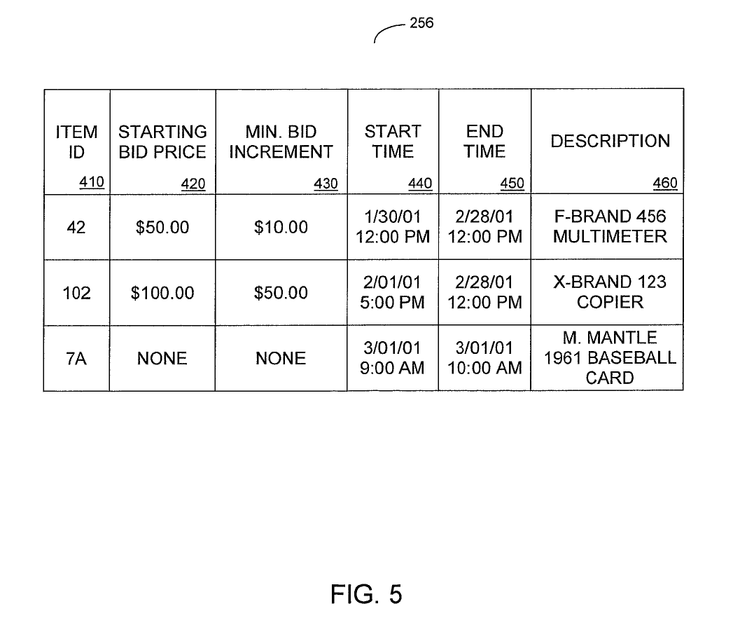

Data storage device 250 also stores auction database 256. Auction database 256 includes information used in conjunction with auction program 252 to conduct one or more auctions. The information of auction database 256 and its use will be discussed in detail below with reference to FIG. 5.

Also included in data storage device 250 are other unshown elements that may be necessary for operation of auction device 200, such as other applications, other data files, an operating system, a database management system and “device drivers” for allowing microprocessor 205 to interface with devices in communication with communication port 215. These elements are known to those skilled in the art, and are therefore not described in detail herein.

User Device

FIG. 4 is a block diagram illustrating an internal architecture of one type of user device 300. User device 300 according to the depicted embodiment includes microprocessor 310, communication port 330, input device 340, display 350, printer 360, RAM 370 and ROM 380, each of which is in communication with communication bus 320. Possible embodiments for each of these components are similar to those described with respect to identically-named components of FIG. 3, although functions performed by the components of FIG. 4 according to the invention may differ from those performed by the components of FIG. 3.

Specifically, communication port 330 may be used to receive auction information from auction device 200 and to transmit a bid to auction device 200, and input device 340 may be used to input a user selection of a desired item and a maximum bid price. Moreover, display 350 and printer 360 may be used to present a picture of an item being auctioned, a description of the item, a starting bid price for the item, a minimum bid increment and other auction information to a user.

Also in communication with communication bus 320 is user storage device 390, which, as shown, stores processor-executable process steps of auction agent 392 and Web browser 394 as well as auction information database 396. User storage device 390 will likely include elements other than those shown in FIG. 4. For example, data storage device 390 may also include data files as well as processor-executable process steps of other applications, device drivers, and an operating system for controlling base processes of user device 300.

Auction agent 392 may include process steps executable to implement process steps 10 of FIG. 1. More specifically, the process steps of auction agent 392 may be executed by microprocessor 310 to identify a plurality of auctions in which an item is being auctioned, and to automatically submit one or more bids to a plurality of the plurality of auctions in order to obtain the item. As a result of these embodiments, auction agent 392 provides automatic execution of a bidding strategy to obtain an item being auctioned in more than one auction for a desired price.

The process steps of auction agent 392 may also provide automatic submission of the one or more bids by allowing identification of one of the plurality of the plurality of auctions having a lowest next bid price for the item, wherein a next bid price in a particular auction for a particular item is based on a sum of a current bid price for the particular item in the particular auction and a minimum bidding increment associated with the particular auction. Additionally, microprocessor 310 may execute the process steps of auction agent 392 to automatically submit the one or more bids by determining whether the lowest next bid price is greater than a maximum bid price, and, if it is determined that the lowest next bid price is not greater than the maximum bid price, by submitting to the one auction a bid for the item, the bid being based on the lowest next bid price.

The process steps of auction agent 392 may be read from a computer-readable medium, such as a floppy disk, a CD-ROM, a DVD-ROM, a Zip disk, a magnetic tape, or a signal encoding the process steps, and then stored in data storage device 390 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

The process steps of Web browser 394 may be executed by microprocessor 310 to provide a user with the ability to transmit information and to receive information such as Web pages over the World Wide Web. In this regard, auction agent 392 may comprise a JAVA™ applet executed by a JAVA Virtual Machine™ provided by Web browser 394.

Auction information database 396 stores information used in conjunction with auction agent 392 to implement the present invention. Accordingly, the information is used to identify a plurality of auctions in which an item is being auctioned, and to automatically submit one or more bids to a plurality of the plurality of auctions in order to obtain the item.

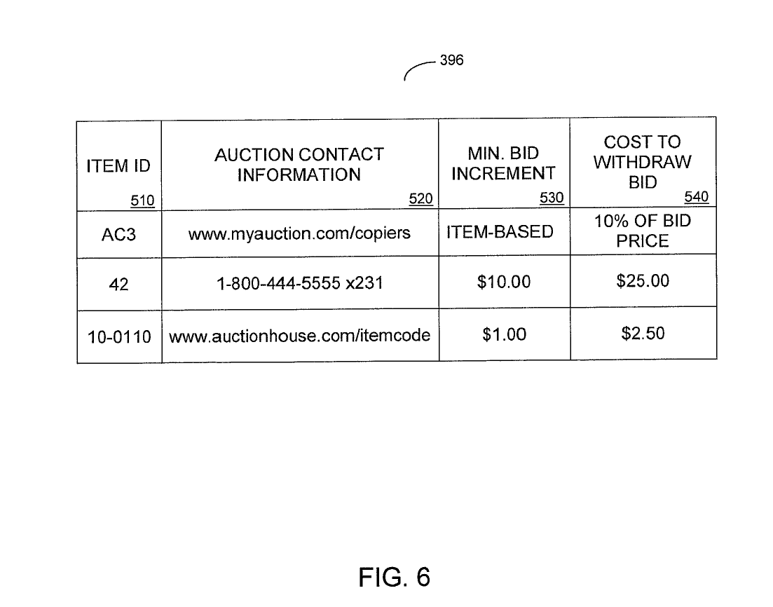

Auction information database 396 and auction database 256 are described in detail below and depicted with sample entries in FIGS. 5 and 6. As will be understood by those skilled in the art, the tabular illustrations and accompanying descriptions of the databases merely represent relationships between stored information. A number of other arrangements may be employed besides those suggested by the tables shown. Similarly, the illustrated entries of the databases represent sample information only; those skilled in the art will understand that the number and content of the entries can be different from those illustrated.

Auction Database

A tabular representation of a portion of auction database 256 is shown in FIG. 5. As shown, auction database 256 includes several records and associated fields. It is contemplated that auction database 256 may include many more records than those shown and that each record may include fields other than those illustrated.

The fields of FIG. 5 specify an item ID 410, a starting bid price 420 associated with the item ID 410, a minimum bid increment 430, a start time 440, an end time 450 and a description 460. Item ID 410 is used by auction device 200 to identify an item being auctioned. Starting bid price 420 is a bid price at which bidding for the item will begin. Accordingly, starting bid price 420 may reflect a lowest price for which a seller is willing to sell the item. All submitted bids must therefore include bid prices greater than or equal to starting bid price 420. As shown, a seller or auctioning entity may choose not to associate a starting bid price 420 with an item ID 410.

Minimum bid increment 430 specifies a minimum amount by which the bid price of a submitted bid must exceed a current bid price in order for the submitted bid to be accepted. For example, in the case of the first record shown in FIG. 5, a first bid for item ID 410 “42” may include a bid price of $50.00. A next bid will be accepted only if the next bid includes a bid price of at least $50.00+$10.00=$60.00, since the associated minimum bid increment 430 is equal to $10.00. A minimum bid increment 430 may be expressed as a fixed amount, a percentage of a current bid price, or in some other manner. Alternatively, an item may be associated with no minimum bid increment 430.

Start time 440 and end time 450 define the period during which an auction for an associated item will be active. More specifically, start time 440 and end time 450 specify the timeframe during which bids for the associated item will be accepted. As shown in FIG. 5, auction database 256 may be used to manage auctions having overlapping or mutually-exclusive active periods. It should be noted that many types of auctions do not have predefined active periods. For example, some auctions terminate after elapsing of a predefined period of time during which no acceptable bids are submitted. Accordingly, for these types of auctions, end time 450 is not defined.

Description 460 includes a description of an associated item. Description 460 may be presented to prospective buyers so that the buyers can determine whether they would like to submit bids for the associated item. Accordingly, description 460 may contain as much or as little detail regarding the item as believed appropriate. Description 460 may include a photograph of the item or means for obtaining further information regarding the item, such as a hyperlink.

In the illustrated portion of auction database 256, each record contains information associated with items being auctioned in a single auction marketplace. For example, the records shown in FIG. 5 may describe items currently being auctioned on the eBay™ website. Auction database 256 may also store information for items being auctioned by several auction marketplaces. In this regard, an item represented in auction database 256 may be auctioned in several marketplaces by several auctioning entities, simultaneously or otherwise. In contrast, some items represented in auction database 256 may be auctioned in only one auction marketplace, with other represented items being auctioned in another auction marketplace.

Auction Information Database

FIG. 6 shows a tabular representation of a portion of auction information database 396 according to embodiments of the invention. The data stored in auction information database 396 may be used in accordance with the invention to identify a plurality of auctions in which an item is being auctioned, and to automatically submit one or more bids to a plurality of the plurality of auctions in order to obtain the item. In the present example, auction information database 396 stores information concerning a single desired item being auctioned in three different auctions. Of course, auction information database 396 may store information regarding additional auctions in which the item is being auctioned, and may store information regarding additional items. Moreover, auction information database 396 may store information in addition to that shown in FIG. 6.

Each record in the tabular portion of auction information database 396 includes fields specifying an item ID 510, auction contact information 520, a minimum bid increment 530 and a cost to withdraw bid 540. In the illustrated example, item ID 510 reflects an ID used to identify an item by an auction with which the item ID 510 is associated. Accordingly, item ID 510 may be submitted along with a bid to an associated auction in order to identify an item for which the bid is being submitted.

Auction contact information 520 includes information using which current auction information can be obtained from or a bid can be submitted to an associated auction. Auction contact information 520 may be input to auction information database 396 by a user using input device 340, may be copied from other databases within user device 300, or may be transmitted to user device 300 via communication port 330 in response to a request from a user. For example, a user may operate Web browser 394 to identify a plurality of auctions in which a desired item is being auctioned, and auction contact information 520 for each identified auction may then be stored manually or automatically in auction information database 396.

A minimum bid increment 530 is similar to a minimum bid increment 430 described above with respect to auction database 256. Minimum bid increment 530 may be used by auction agent 392 to identify an auction having a lowest next bid price in accordance with the present invention. An example of such usage is set forth below.

Cost to withdraw bid 540 associated with an auction indicates a monetary cost which will be incurred by a user if the user withdraws an already-submitted bid from the auction. Of course, some auctions may not allow a user to withdraw a bid, while others may allow a user to withdraw a bid at no cost to the user. According to the present embodiment, cost to withdraw bid 540 is one factor used by auction agent 394 to determine whether or not to withdraw a current bid from an auction and to submit another bid in the same or another auction.

Specific Example

The process steps of FIG. I and the other process steps set forth herein are described as being performed by user device 300 through execution of processor-executable process steps of auction agent 392 by microprocessor 310. However, the process steps may also be performed, in whole or in part, by one or more of user devices 300, auction devices 200, other devices, and manual means. In one alternative example, a user may access a third-party website or a call center using user device 300 and input a desired item and a maximum bid price to the website/call center. Next, the website/call center may execute process steps in order to obtain the desired item in accordance with embodiments of the invention.

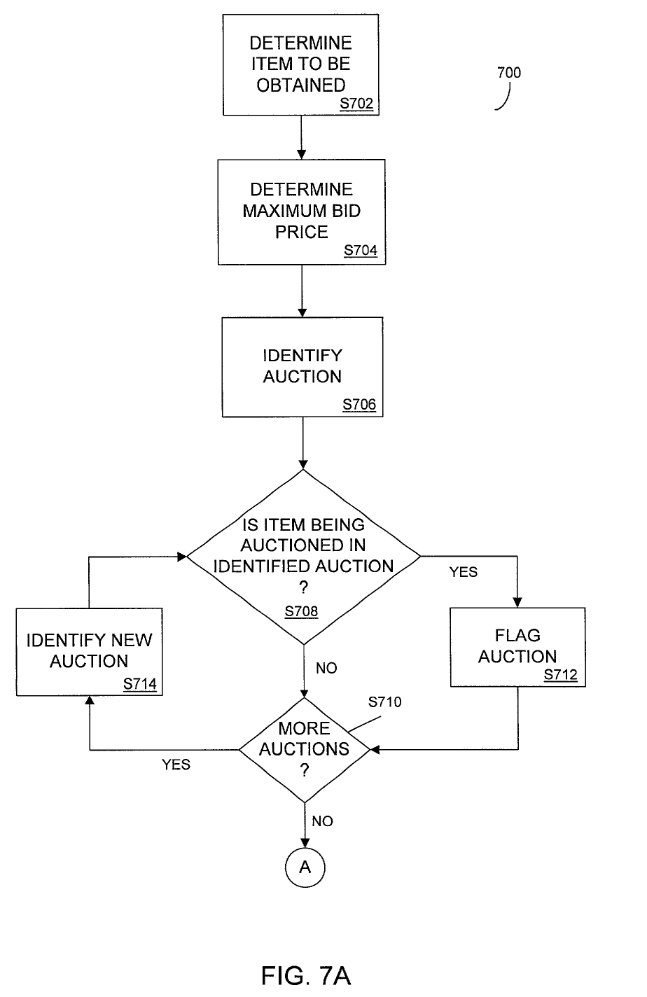

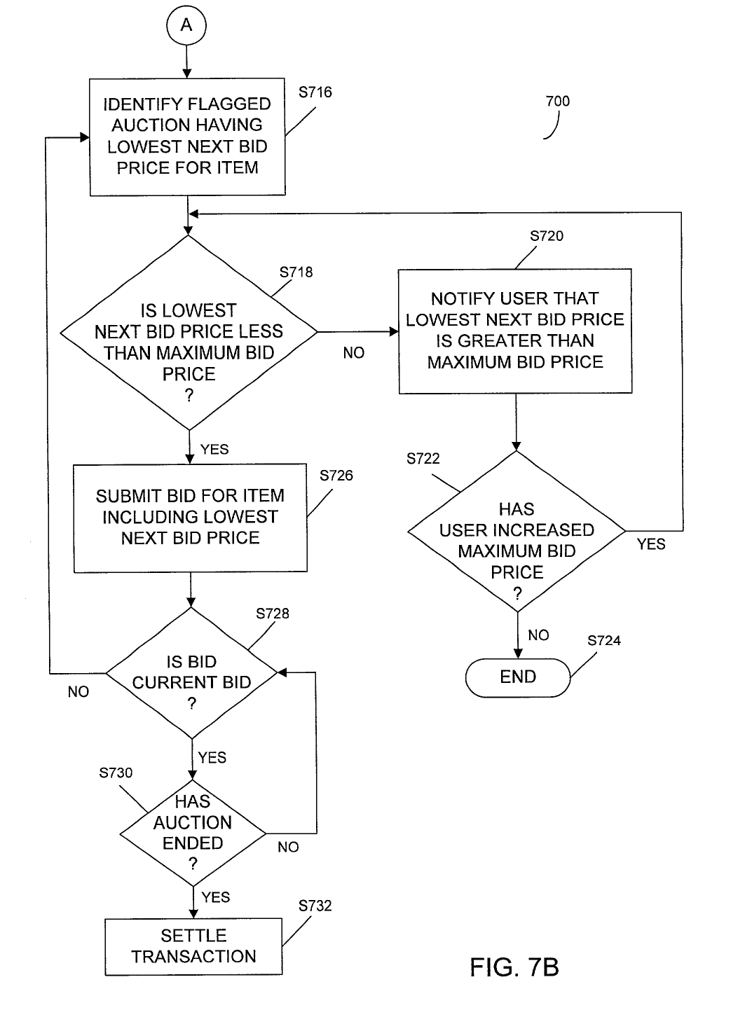

FIGS. 7A and 7B illustrate process steps 700. Briefly, process steps 700 identify a plurality of auctions in which an item is being auctioned, and automatically submit one or more bids to a plurality of the plurality of auctions in order to obtain the item. Flow begins at step S702, in which an item to be obtained is determined. In one embodiment of step S702, the item is determined by presenting an inquiry to a user through display 350 and by receiving from the user an indication of a desired item through input device 340. In this regard, the user may be presented with a list of items currently being auctioned and asked to select an item from the list, or may be asked to input a name of a desired item. Of course, many other systems for determining an item to be obtained may be used in accordance with the present invention.

After step S702, a maximum bid price is determined in step S704. A maximum bid price is a maximum price that the user is willing to pay for the determined item. The maximum bid price may be determined in step S704 by requiring the user to input a maximum bid price using input device 340. In a case that a user is willing to pay any price in order to obtain the item, the maximum bid price may be determined to be “none” in step S704.

An auction is then identified in step S706. Such identification may be accomplished by using known Web searching techniques, by referring to a stored list of auctions, or by using a third-party website for identifying auctions. After the auction is identified, it is determined in step S708 whether the determined item is being auctioned in the identified auction. If the item is not being auctioned, flow proceeds to step S710 to determine whether more auctions remain to be considered in step S708. If the item is being auctioned, flow proceeds from step S708 to step S712 in order to flag the auction for future consideration, and then on to step S710. A new auction is identified in step S714 if it is determined in step S710 that more auctions remain to be considered. Flow then continues to step S708 as described above.

Flow cycles through steps S708, S710, S712 and S714 until it is determined in step S710 that no more auctions remain to be considered. At this point of process steps 700, two or more auctions have been flagged as auctioning the item to be obtained. According to some embodiments, steps S706 through S714 are periodically executed during subsequent steps of process steps 700 in order to identify any auctions which may begin auctioning the item during execution of the subsequent process steps.

In step S716 of FIG. 7B, one of the flagged auctions is identified as having a lowest next bid price for the item. A next bid price is a bid price of a bid which, if submitted, would become a current bid in an auction for a particular item. For example, if a current bid in an auction for an item includes a bid price of $20.00 and a minimum bid increment associated with the auction is $5.00, the next bid price for the auction is $25.00. Of course, if no minimum bid increment is associated with the auction, the next bid price would be $20.01.

In order to identify an auction in step S716, auction contact information 520 for a flagged auction is used in conjunction with an associated item ID 510 to determine a bid price of the current bid in the auction. The bid price is added to an associated minimum bid increment 530 to determine the next bid price for the flagged auction. The process is repeated for each flagged auction and the next bid prices are compared to identify the flagged auction having the lowest next bid price.

Next, it is determined in step S718 whether the lowest next bid price is less than the maximum bid price determined in step S704. If not, flow proceeds to step S720, wherein the user is notified that the lowest next bid price is greater than the maximum bid price. The user is notified in step S720 because the user will not obtain the item unless the user indicates that he is willing to pay more than the maximum bid price for the item. Accordingly, the user is given an opportunity to increase the maximum bid price in step S722. If the user does not increase the maximum bid price, flow proceeds to step S724 and terminates therein.

If the user increases the maximum bid price in step S722, flow returns to step S718 to determine whether or not the lowest next bid price is less than the increased maximum bid price. Flow continues to step S726 in a case that the lowest next bid price is less than the maximum bid price. In step S726, a bid is submitted to the flagged auction identified in step S716, the bid including the lowest next bid price. Again, the bid may be submitted using auction contact information 520 associated with the identified auction and an item ID 510 associated with the auction and the item to be obtained.

Once the bid is submitted in step S726, the submitted bid becomes the current bid in the identified flagged auction. It is then determined in step S728 whether the submitted bid is still the current bid in the auction. That is, it is determined whether a bid has been submitted by another entity to the auction including a bid price greater than the previously-determined lowest next bid price. If such a bid has been submitted, flow returns to step S716 and proceeds therefrom as described above.

If the bid submitted in step S726 is still the current bid, it is determined in step S730 whether or not the auction to which the bid was submitted has ended. If not, flow returns to step S728. Accordingly, flow cycles between step S728 and step S730 until the submitted bid is no longer the current bid or until the auction ends. Once the auction ends, flow continues from step S730 to step S732, wherein a transaction to purchase the item for the current bid price is settled between the user and the seller and/or the auctioning entity.

Alternate Embodiments

Although the present invention was described above in the context of a traditional auction process, it should be noted that the invention may be used in conjunction with other types of auctions. These auctions include, but are not limited to: an English auction; a Dutch auction; a single-sided auction; a double-sided auction; a single-quantity auction; a multiple-quantity auction; a first price auction; a Vickerey auction; a multi-attribute auction; a sell-side auction; and a buy-side auction.

In some embodiments, the present invention considers the possibility of withdrawing a submitted bid. For example, a bid submitted according to the invention may be a current bid for an item in a particular auction. If a previously unidentified auction in which the item is being auctioned is identified, it may be beneficial to withdraw the submitted bid and to submit a bid to the previously unidentified auction. In order to determine whether to withdraw the bid, a cost, if any, of withdrawing the bid and a next bid price of the previously unidentified auction may be considered. Thus, in one embodiment, the bid is withdrawn and a new bid is submitted to the previously unidentified auction if the bid price of the submitted bid is greater than the sum of the next bid price of the previously unidentified auction and the cost to withdraw the submitted bid. In other embodiments, also considered are the relative probabilities that the submitted bid and a bid reflecting the next bid price of the previously unidentified auction will prevail in their respective auctions.

According to other embodiments, the maximum bid price may be based on variables such as market factors. For example, a maximum bid price in a process to obtain an automobile may be automatically adjusted based on oil prices, prices of comparable automobiles, or the price of a 30-year U.S. Treasury note.

In related embodiments, automatic bidding processes and strategies according to the invention may be based on factors such as recent bidding history of all buyers, of all sellers, of an individual buyer or of a set of buyers. Automatic bidding may also be based on bidding histories for items similar to the item to be obtained, bidding histories for items complementary to the item to be obtained, and bidding histories for items substitutable for the item to be obtained. By basing automatic bidding on bidding histories, it may be possible to obtain a desired item for a lower price than otherwise possible.

Also considered may be transaction histories of a particular buyer, seller, or set of buyers or sellers, demographics of a particular buyer, seller, or set of buyers or sellers, and psychographics of a particular buyer, seller or set of buyers or sellers. Furthermore, automatic bidding processes and strategies according to the invention may be based on news events, analysts' reports and supply chain information such as production capacity, projected demand and inventory levels.

According to another alternative embodiment, a user may input two or more different items with an indication that the user desires only one of the different items. Bidding according to such an embodiment may proceed along the lines of process steps 700, with each of the different items treated as the item to be obtained. Therefore, all auctions in which one of the different items is being auctioned are flagged in step S712 and each of the flagged auctions are considered in identifying the auction having the lowest next bid price.

In a further aspect, the user may assign values to each of the two or more different items indicating the user's relative desire to obtain each item. The values may be used to determine a lowest next bid price. For example, if one flagged auction has a next bid price of $25.00 for an item having a low assigned value and a second auction has a next bid price of $25.50 for an item having a high assigned value, the second auction may be identified in step S716 as having a lowest next bid price. It will also be noted that the present invention may be used to obtain multiple units of a same item or multiple items from one or more auctions.

Although the present invention has been described with respect to particular embodiments thereof, those skilled in the art will note that various substitutions may be made to those embodiments described herein without departing from the spirit and scope of the present invention.

What is claimed is:

1. A method for obtaining an item, comprising:
identifying a plurality of auctions in which an item is being auctioned; and
automatically submitting one or more bids to a plurality of the plurality of auctions in order to obtain the item.

2. A method according to claim 1, wherein the step of automatically submitting one or more bids comprises:
identifying one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

3. A method according to claim 2, wherein the step of automatically submitting one or more bids further comprises:
determining whether the lowest next bid price is greater than a maximum bid price; and, if it is determined that the lowest next bid price is not greater than the maximum bid price,
submitting to the one auction a bid for the item, the bid being based on the lowest next bid price.

4. A method according to claim 2, wherein the step of automatically submitting one or more bids further comprises:
determining whether the lowest next bid price is greater than a maximum bid price; and, if it is determined that the lowest next bid price is greater than a maximum bid price,
presenting an indication that the lowest next bid price is greater than the maximum bid price and determining another maximum bid price greater than the lowest next bid price.

5. A method according to claim 1, wherein the step of automatically submitting one or more bids further comprises:
determining that a submitted bid has been surpassed; and
automatically submitting another bid to at least one of the plurality of the plurality of auctions in order to obtain the item.

6. A method according to claim 5, wherein the step of automatically submitting another bid comprises:
identifying one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

7. A method according to claim 6, wherein the step of automatically submitting another bid further comprises:
determining whether the lowest next bid price is greater than a maximum bid price; and, if it is determined that the lowest next bid price is not greater than the maximum bid price,
submitting to the one auction a bid for the item, the bid being based on the lowest next bid price.

8. A method according to claim 6, wherein the step of automatically submitting another bid further comprises:
determining whether the lowest next bid price is greater than a maximum bid price; and, if it is determined that the lowest next bid price is greater than a maximum bid price,
presenting an indication that the lowest next bid price is greater than the maximum bid price and determining another maximum bid price greater than the lowest next bid price.

9. A method according to claim 1, further comprising:
withdrawing a previously-submitted bid.

10. A method according to claim 9, further comprising:
determining that the bid price of the previously-submitted bid is greater than a sum of a next bid price of one of the plurality of auctions and a cost to withdraw the previously-submitted bid.

11. A method according to claim 1, wherein the step of automatically submitting one or more bids comprises:
analyzing at least one of group bidding history and individual bidding history.

12. A method according to claim 1, wherein the step of automatically submitting one or more bids comprises:
analyzing at least one of a bidding history for an item similar to the item, a bidding history for items complementary to the item, and a bidding history for items substitutable for the item.

13. A method according to claim 3, wherein the maximum bid price is based on market factors.

14. A method according to claim 1, wherein the step of automatically submitting one or more bids to a plurality of the plurality of auctions comprises:
automatically submitting one or more bids to a plurality of the plurality of auctions in order to obtain more than one unit of the item.

15. A method for obtaining an item, comprising:
identifying a plurality of items; and
automatically submitting one or more bids to one or more auctions in order to obtain one of the items.

16. A method for obtaining an item, comprising:
identifying an item; and
automatically submitting one or more bids to one or more auctions in order to obtain a plurality of the item.

17. An apparatus, comprising:
a processor; and
a storage device in communication with said processor and storing instructions adapted to be executed by said processor to:
identify a plurality of auctions in which an item is being auctioned; and
automatically submit one or more bids to a plurality of the plurality of auctions in order to obtain the item.

18. An apparatus according to claim 17, wherein the stored instructions adapted to be executed by said processor to automatically submit one or more bids further comprise instructions adapted to be executed by said processor to:
identify one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

19. An apparatus according to claim 18, wherein the stored instructions adapted to be executed by said processor to automatically submit one or more bids further comprise instructions adapted to be executed by said processor to:
determine whether the lowest next bid price is greater than a maximum bid price; and, if it is determined that the lowest next bid price is not greater than the maximum bid price,
submit to the one auction a bid for the item, the bid being based on the lowest next bid price.

20. An apparatus according to claim 18, wherein the stored instructions adapted to be executed by said processor to automatically submit one or more bids further comprise instructions adapted to be executed by said processor to:
determine whether the lowest next bid price is greater than a maximum bid price; and, if it is determined that the lowest next bid price is greater than a maximum bid price,
present an indication that the lowest next bid price is greater than the maximum bid price and determining another maximum bid price greater than the lowest next bid price.

21. An apparatus according to claim 17, wherein the stored instructions adapted to be executed by said processor to automatically submit one or more bids further comprise instructions adapted to be executed by said processor to:
determine that a submitted bid has been surpassed; and
automatically submit another bid to at least one of the plurality of the plurality of auctions in order to obtain the item.

22. An apparatus according to claim 21, wherein the stored instructions adapted to be executed by said processor to automatically submit another bid further comprise instructions adapted to be executed by said processor to:
identify one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

23. An apparatus according to claim 22, wherein the stored instructions adapted to be executed by said processor to automatically submit another bid further comprise instructions adapted to be executed by said processor to:
determine whether the lowest next bid price is greater than a maximum bid price; and, if it is determined that the lowest next bid price is not greater than the maximum bid price,
submit to the one auction a bid for the item, the bid being based on the lowest next bid price.

24. An apparatus according to claim 22, wherein the stored instructions adapted to be executed by said processor to automatically submit another bid further comprise instructions adapted to be executed by said processor to:
determine whether the lowest next bid price is greater than a maximum bid price; and, if it is determined that the lowest next bid price is greater than a maximum bid price,
present an indication that the lowest next bid price is greater than the maximum bid price and determining another maximum bid price greater than the lowest next bid price.

25. An apparatus according to claim 17, wherein the stored instructions adapted to be executed by said processor further comprise instructions adapted to be executed by said processor to withdraw a previously-submitted bid.

26. An apparatus according to claim 25, wherein the stored instructions adapted to be executed by said processor to withdraw a previously-submitted bid further comprise instructions adapted to be executed by said processor to:
determine that the bid price of the previously-submitted bid is greater than a sum of a next bid price of one of the plurality of auctions and a cost to withdraw the previously-submitted bid.

27. An apparatus according to claim 17, wherein the stored instructions adapted to be executed by said processor to automatically submit one or more bids further comprise instructions adapted to be executed by said processor to:
analyze at least one of group bidding history and individual bidding history.

28. An apparatus according to claim 17, wherein the stored instructions adapted to be executed by said processor to automatically submit one or more bids further comprise instructions adapted to be executed by said processor to:
analyze at least one of a bidding history for an item similar to the item, a bidding history for items complementary to the item, and a bidding history for items substitutable for the item.

29. An apparatus according to claim 19, wherein the maximum bid price is based on market factors.

30. An apparatus according to claim 17, wherein the stored instructions adapted to be executed by said processor to automatically submit one or more bids further comprise instructions adapted to be executed by said processor to:
automatically submit one or more bids to a plurality of the plurality of auctions in order to obtain more than one unit of the item.

31. An apparatus, comprising:
a processor; and
a storage device in communication with said processor and storing instructions adapted to be executed by said processor to:
identify a plurality of items; and
automatically submit one or more bids to one or more auctions in order to obtain one of the items.

32. An apparatus, comprising:
a processor; and
a storage device in communication with said processor and storing instructions adapted to be executed by said processor to:
identify an item; and
automatically submit one or more bids to one or more auctions in order to obtain a plurality of the item.

33. A medium storing processor-executable process steps, the process steps comprising:
a step to identify a plurality of auctions in which an item is being auctioned; and
a step to automatically submit one or more bids to a plurality of the plurality of auctions in order to obtain the item.

34. A medium according to claim 33, wherein the step to automatically submit one or more bids comprises:
a step to identify one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

35. A medium according to claim 34, wherein the step to automatically submit one or more bids further comprises:
a step to determine whether the lowest next bid price is greater than a maximum bid price; and, if it is determined that the lowest next bid price is not greater than the maximum bid price,
a step to submit to the one auction a bid for the item, the bid being based on the lowest next bid price.

36. A medium according to claim 34, wherein the step to automatically submit one or more bids further comprises:
a step to determine whether the lowest next bid price is greater than a maximum bid price; and, if it is determined that the lowest next bid price is greater than a maximum bid price,
a step to present an indication that the lowest next bid price is greater than the maximum bid price and determining another maximum bid price greater than the lowest next bid price.

37. A medium according to claim 33, wherein the step to automatically submit one or more bids further comprises:
a step to determine that a submitted bid has been surpassed; and
a step to automatically submit another bid to at least one of the plurality of the plurality of auctions in order to obtain the item.

38. A medium according to claim 37, wherein the step to automatically submit another bid comprises:
a step to identify one of the plurality of the plurality of auctions having a lowest next bid price for the item,
wherein a next bid price in a particular auction for a particular item is based on a sum of a current bid price for the particular item in the particular auction and a minimum bidding increment associated with the particular auction.

39. A medium according to claim 38, wherein the step to automatically submit another bid further comprises:
a step to determine whether the lowest next bid price is greater than a maximum bid price; and, if it is determined that the lowest next bid price is not greater than the maximum bid price,
a step to submit to the one auction a bid for the item, the bid being based on the lowest next bid price.

40. A medium according to claim 38, wherein the step to automatically submit another bid further comprises:
a step to determine whether the lowest next bid price is greater than a maximum bid price; and, if it is determined that the lowest next bid price is greater than a maximum bid price,
a step to present an indication that the lowest next bid price is greater than the maximum bid price and to determine another maximum bid price greater than the lowest next bid price.

41. A medium according to claim 33, the process steps further comprising:
a step to withdraw a previously-submitted bid.

42. A medium according to claim 41, the process steps further comprising:
a step to determine that the bid price of the previously-submitted bid is greater than a sum of a next bid price of one of the plurality of auctions and a cost to withdraw the previously-submitted bid.

43. A medium according to claim 33, wherein the step to automatically submit one or more bids comprises:
a step to analyze at least one of group bidding history and individual bidding history.

44. A medium according to claim 33, wherein the step to automatically submit one or more bids comprises:
a step to analyze at least one of a bidding history for an item similar to the item, a bidding history for items complementary to the item, and a bidding history for items substitutable for the item.

45. A medium according to claim 35, wherein the maximum bid price is based on market factors.

46. A medium according to claim 33, wherein the step to automatically submit one or more bids to a plurality of the plurality of auctions comprises:
a step to automatically submit one or more bids to a plurality of the plurality of auctions in order to obtain more than one unit of the item.

47. A medium storing processor-executable process steps, the process steps comprising:
a step to identify a plurality of items; and
a step to automatically submit one or more bids to one or more auctions in order to obtain one of the items.

48. A medium storing processor-executable process steps, the process steps comprising:
a step to identify an item; and
a step to automatically submit one or more bids to one or more auctions in order to obtain a plurality of the item.
